(19) United States
(12) Patent Application Publication
(10) Pub. No.: US 2015/0156268 A1
(43) Pub. Date: Jun. 4, 2015

(54) Suggesting Topics For Social Conversation

(71) Applicants: Mordechai Teicher, Hod Hasharon (IL); Eitan Lev, Even Yehuda (IL); Conduit Ltd, Ness Ziona (IL)

(72) Inventors: Eitan Lev, Even Yehuda (IL); Mordechai Teicher, Hod Hasharon (IL)

(21) Appl. No.: 14/096,074

(22) Filed: Dec. 4, 2013

(51) Int. Cl. H04L 29/08

(52) U.S. Cl. CPC H04L 67/22

(57) ABSTRACT

A method and system for suggesting conversation topics to a participant in a social conversation. A conversation log is maintained for the participant, containing records of the times, durations, and parties of previous conversations. When the participant engages in a subsequent conversation with a party, the conversation log is searched to obtain the time of the most recent previous conversation with that party. Social media and other publications subsequent to that time are searched for subjects that can be presented to the participant as topics of conversation. In contrast to other schemes related to conversational topics, no voice analysis of the conversations is required.

### FIELD

The present invention relates to voice conversation, and in particular to voice conversation conducted via, or with the assistance of, computerized devices.

### BACKGROUND

Voice communications are commonplace, in forms such as phone calls, voice over IP (VOIP), or video chats. Compared to other forms of interpersonal communication, such as emails, instant messages (IM) or short text messages (SMS), voice communications are often lengthier and more interactive. Generally speaking, voice communications are the most widespread form of remote social interaction, particularly in the form of social conversations.

It is often desirable for a participant in a social conversation to have a set of topics around which to structure the conversation. Current solutions for suggesting topics for social conversation typically involve databases of topics and keywords and/or automatic machine analysis of social conversations to detect key words used by the participants, for determining topics of a previous or present social conversation. Drawbacks of these methods include lack of precision in automatic voice recognition and human language interpretation, as well as the fact that topics of previous conversations may not necessarily be of interest to the participants of a present conversation.

Accordingly, it would be desirable and beneficial to have methods and systems for suggesting topics for a social conversation that do not require automated voice analysis, and which may be of interest to a participant of a social conversation, independent of previous conversational topics. This goal is met by embodiments of the present invention.

### SUMMARY

Embodiments of the present invention provide methods and systems for presenting suggested topics to a participant in a social conversation. The suggested topics are based on recent published events and status changes with respect to one or more participants of the conversation, where the events and changes have been published subsequent to the most recent previous conversation between the participants. According to certain embodiments of the invention, the events and status changes are published via social media associated with the respective participants, non-limiting examples of which include: publication on a web log (“blog”); posting via a social network service; and personal statuses as determined by data mining on public networks.

According to an embodiment of the present invention, a conversation log is maintained for a conversation participant, which records a time of the conversation (a timestamp, non-limiting examples of which include the starting time of the conversation), the other participant(s) of the conversation, and the duration of the participant's involvement in the conversation. In various embodiments, the purpose of the conversation log is to determine when a particular set of conversation participants last conversed, and therefore to determine events and changes of prospective statuses that have transpired since these participants held their most recent previous conversation.

Unlike current systems related to conversational topics, embodiments of the present invention operate independently of the topics discussed in previous and current conversations, and therefore, according to certain embodiments, no information about the topics of the conversations are recorded. In particular, unlike current systems related to conversational topics, certain embodiments of the present invention have no need to determine or identify the topics of any conversation, and therefore require no speech analysis or parsing of conversations. According to other embodiments, obtaining the text of a voice conversation can assist in determining various aspects of a voice conversation, and this can be of benefit in carrying out certain features of the present invention. In a non-limiting example, analyzing a brief voice communication to obtain a text representation thereof may enable determining the time of an anticipated upcoming social conversation, and/or the time of a recent previous social conversation which may not have been logged in any other manner.

### DEFINITIONS

The term “voice communication” herein denotes a human speech transmission from one individual to at least one other individual in real time, either directly in person (such as by a face-to-face encounter) or via electronic communication means including, but not limited to: telephony, wired or wireless; radio communications; and data communication, such as voice over IP (VOIP) or networked conferencing.

The terms “voice conversation” and “conversation” are herein treated as synonymous and denote overlapping and/or interspersed interactive voice communications among two or more participants, all of whom are simultaneously able to hear voice communications of the other participant(s). In various embodiments of the present invention, a conversation may be spontaneous, i.e., the voice communication is not predetermined, but may be generated on an ad hoc basis by a participant. In a related embodiment, the voice communication of the participant is generated in response to a previous voice communication by another participant. In certain embodiments, as long as at least two participants remain in the conversation, a third participant may leave the conversation without terminating the conversation. In a related embodiment, a new participant may join the conversation after the conversation has begun.

The term “starting time” in the context of a conversation, herein denotes the time (including both calendar date and clock time) when at least two participants begin the conversation. The term “ending time” similarly denotes the time (including both calendar date and clock time) when there are no longer at least two participants in the conversation. The term “duration” in the context of a conversation herein denotes the elapsed time between the starting time and the ending time of the conversation.

The term “topic” in the context of a conversation herein denotes a heading or summary of a subject that is presented and/or proposed by a participant of the conversation, and/or is discussed among the participants during the conversation. In various embodiments of the invention, a topic is presented to a user, a participant or prospective participant of a social conversation, as a suggestion for discussion during the conversation.

The term “subject” in the context of a conversation herein denotes published content from which a conversation topic may be derived. According to certain embodiments of the invention, a topic can be all of a subject or at least a portion of a subject, non-limiting examples of which include: a heading or title of the subject; a photograph or video clip embedded within the subject; and the first ten words of subject text. According to a related embodiment, the topic is a link to the subject, wherein a link to a subject is herein considered to be a portion of the subject.

According to various embodiments of the present invention, certain potential subject sources, such as blogs and news feeds, are filtered according to predefined selection criteria in order to obtain suitable subjects. Non-limiting examples of selection criteria include: a party's name appears in a paragraph or headline (e.g., in the society pages of a newspaper); and a published reader communication (e.g., letter to the editor) is from a party.

In an embodiment of the present invention, a subject also includes the publication data, such as an identifier of the publisher and the date-time of publication. The term “published” herein denotes that the content is available to members of the public, optionally including members of the general public without restriction as well as members of the public (such as individuals and organizations) who are specially-qualified to receive the content. Non-limiting means of being specially-qualified to receive content include: having a subscription to a publication service which distributes the content; having a membership in an association or group which publishes the content; having an account with a social media organization which posts the content; and being a member of a circle that exchange personal content only between peers.

The term “social conversation” herein denotes a conversation dealing with topics of social interest to the participants, as opposed to business or operational conversations, which deal with topics of commercial, financial, professional, academic, institutional, or work-related interest. In certain embodiments of the present invention, participants of a social conversation are friends and/or relatives. In a related embodiment, participants of a social conversation discuss events, news, feelings, and/or opinions, both as new topics of conversation and as updated topics.

In an embodiment of the present invention, for a conversation to be a social conversation, the conversation must have a duration that is at least a predefined minimum of time. As defined here, this is equivalent to having a duration that exceeds a predefined threshold.

There is thus provided, in accordance with an embodiment of the present invention, a method of operating a processor for suggesting to a first party a conversation topic for a social conversation with a second party, the method including: (a) retrieving, from a conversation log of the first party, a time of the most recent previous social conversation involving the first party and the second party; (b) obtaining a recently-published subject that was published subsequent to the time of the most recent social conversation; and (c) presenting, to the first party, at least a portion of the recently-published subject, as a suggested conversation topic.

There is also provided, in accordance with another embodiment of the present invention, an apparatus for suggesting to a first party a conversation topic for a social conversation with a second party, the apparatus comprising: (a) a processor, for executing instructions; (b) a display screen coupled to the processor, for displaying information; (c) a non-transitory data storage coupled to the processor, and storing executable instructions, which instructions, when executed by the processor, cause the processor to perform: (d) retrieving, from a conversation log of the first party, a time of the most recent social conversation involving the first party and the second party; (e) obtaining a recently-published subject that was published subsequent to the time of the most recent social conversation; and (f) presenting to the first party, via the display screen, at least a portion of the recently-published subject as a suggested conversation topic.

There is moreover provided, in accordance with still another embodiment of the present invention, a computer product for suggesting to a first party a conversation topic for a social conversation with a second party, the computer product including non-transitory media containing a set of executable instructions, which instructions, when executed by a processor of a user device cause the user device to: (a) access a telephone log of the first party; (b) determine a time of the most recent social conversation between the first party and the second party from the telephone log; (c) request from a remote server a published subject of interest for the social conversation, such that the published subject of interest was published subsequent to the recent social conversation between the first party and the second party; and (d) present the published subject of interest to the first party as a suggested topic of social conversation.

### BRIEF DESCRIPTION OF THE DRAWINGS

The present invention will be understood and appreciated more fully from the following detailed description, taken in conjunction with the drawings in which:

FIG. 1 illustrates the elements of a conversation and topics for suggestion according to an embodiment of the present invention.

FIG. 2 illustrates the participants of a conversation according to another embodiment of the invention.

FIG. 3A illustrates a conversation record of a conversation log according to various embodiments of the present invention.

FIG. 3B illustrates a subject which can be suggested as a topic for social conversation, according to various embodiments of the present invention.

FIG. 4A is a flowchart of a method for suggesting a topic for a social conversation according to certain embodiments of the present invention.

FIG. 4B is an expansion of a method step for a variation of the method shown in FIG. 4A, according to an embodiment of the present invention.

FIG. 4C is another expansion of a method step for a variation of the method shown in FIG. 4A, according to another embodiment of the present invention.

FIG. 4D is a further expansion of a method step for a variation of the method shown in FIG. 4A, according to a further embodiment of the present invention.

FIG. 5 conceptually illustrates a system and apparatus for suggesting social conversation topics to a user, according to an embodiment of the present invention.

### DETAILED DESCRIPTION

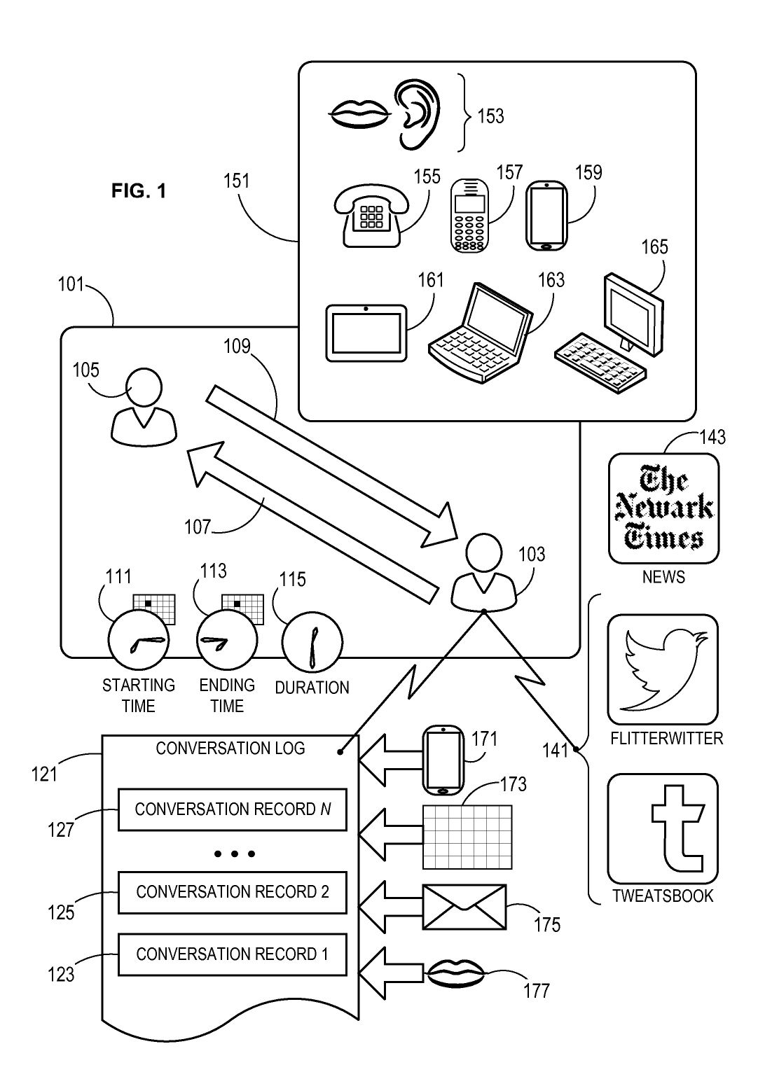

FIG. 1 illustrates the elements of a conversation 101 and topics for suggestion according to an embodiment of the present invention. A first party 103 and a second party 105 interact via a voice communication 107 and a voice communication 109, respectively. Voice communication channels 151 include, but are not limited to: a direct audible channel 153 when parties 103 and 105 are in voice proximity, such as during a face-to-face meeting; a landline telephony channel 155; a cellular telephony channel 157; a smartphone channel 159; a tablet computer channel 161; a portable computer channel 163; and a stationary computer channel 165. Excluding direct audible channel 153, the devices may involve the transport of signals over telephony networks and/or data networks, such as the Internet. In addition, it is understood that first party 103 and second party 105 may employ different types of devices. In a non-limiting example, first party 103 may employ a smartphone while second party 105 may employ a landline channel.

As defined previously, according to various embodiments of the invention conversation 101 is characterized by a starting time 111, an ending time 113, and a duration 115.

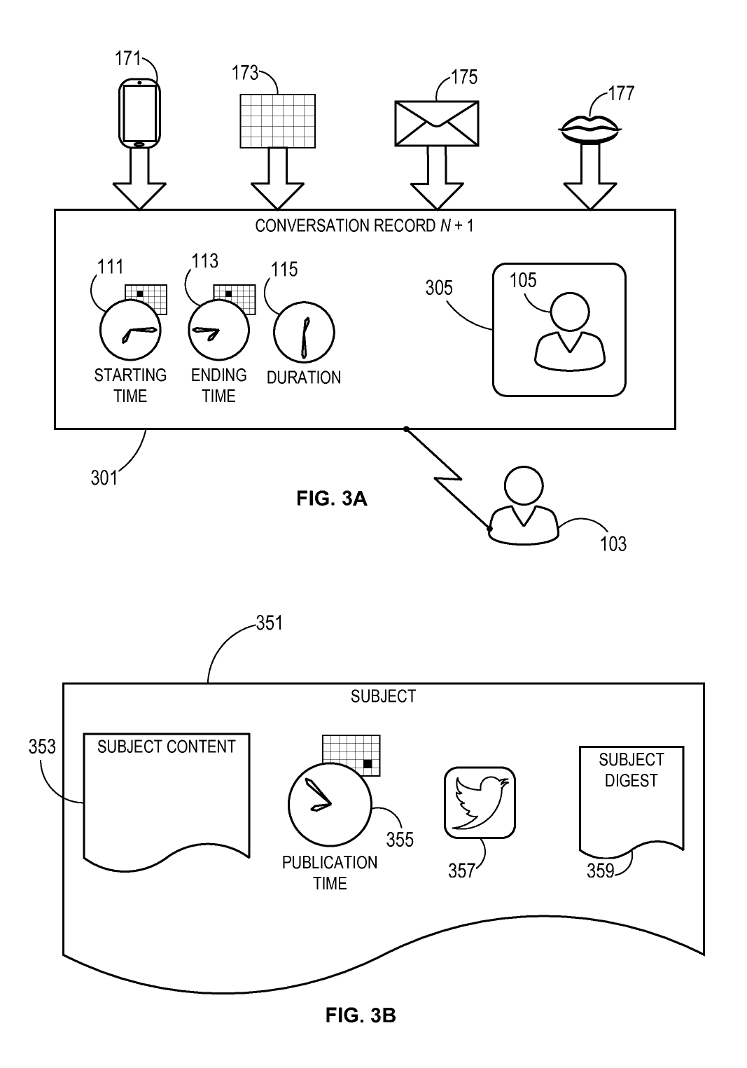

According to various embodiments of the invention, a conversation log 121 is associated with first party 103. Conversation log 121 includes one or more conversation records, illustrated in FIG. 1 as a conversation record 123, a conversation record 125, and a conversation record 127. According to certain embodiments of the present invention, data in a conversation log may be acquired from a variety of sources in a variety of ways, non-limiting examples of which are described herein below, and as illustrated in FIG. 1 and FIG. 3A. Conversation records in conversation log 121 are not necessarily recording of actual conversations, but may be concise records that a conversation has been held, along with the time and duration of the conversation, as described herein below with reference to FIG. 3A and FIG. 3B. Information about conversations may come from one or more of a variety of sources. In one embodiment of the invention, a record of a conversation log is based at least in part on data from a telephone log of a telephone 171. In another embodiment, a record of a conversation log is based at least in part on a calendar entry of a calendar 173. In still another embodiment, a record of a conversation log is based at least in part on contents of an e-mail message 175. In a further embodiment, a record of a conversation log is based at least in part on an analysis of a voice communication 177, whether recorded or not, whether analyzed automatically or not, and whether analyzed offline or in real time. In related embodiments of the invention, second party 105 also has an associated conversation log (not illustrated).

Certain embodiments of the invention provide that first party 103 be associated with postings in social media 141. In one related embodiment, first party 103 is the originator of a new posting in social media 141. In another related embodiment, first party 103 is an updater of an existing posting in social media 141.

Certain further embodiments of the invention provide that second party 105 be associated with postings in social media 141. In one related embodiment, second party 105 is the originator of a new posting in social media 141. In another related embodiment, second party 105 is an updater of an existing posting in social media 141.

In other embodiments, a public news outlet 143 publishes a news subject that is related or may be of interest to first party 103, and in further embodiments, public news outlet 143 publishes a news subject that is related or may be of interest to second party 105.

According to various embodiments of the invention, both social media in general and public news outlets in general are potential sources of subjects for conversation topics. In the illustrations herein, social media 141 and public news outlet 143 are fictitious, and are intended for purposes of illustration only.

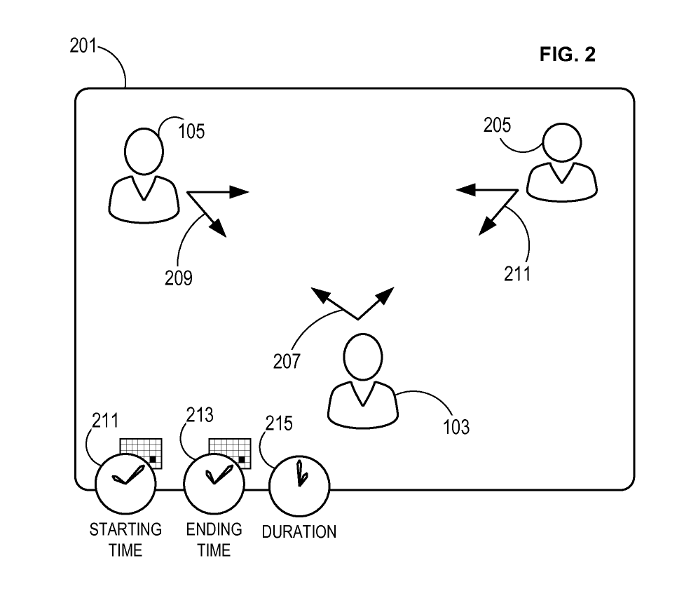

FIG. 2 illustrates a conversation 201 according to certain embodiments of the present invention, in which a third party 205 participates along with first party 103 and second party 105. In conversation 201 first party 103 interacts with both second party 105 and third party 205 via a voice communication 207; second party 105 interacts with both first party 103 and third party 205 via a voice communication 209; and third party 205 interacts with both first party 103 and second party 105 via a voice communication 211. Conversation 201 has a starting time 211, an ending time 213, and a duration 215. As with conversation 101 of FIG. 1, the participants of conversation 201 may interact via direct audible channel 153, or may interact via channels supported by devices 155, 157, 159, 161, 163, 165, or by other devices capable of supporting remote voice communications. As before, different participants may utilize different device channels. In a non-limiting example, first party 103 may employ a tablet computer using a Voice over Internet Protocol (VoIP), second party may employ a cellular telephone using a cellular telephony network, and third party 205 may employ a landline telephone using a landline telephony network.

In further embodiments of the invention, more than three parties may participate in a voice conversation in similar fashion.

FIG. 3A illustrates a conversation record 301 of a conversation log (illustrated herein in a non-limiting example as conversation log 121 of FIG. 1) according to various embodiments of the present invention. In FIG. 3A, conversation record 301 is a new record to be added to conversation log 121 at the conclusion of conversation 101. Conversation record 301 includes starting time 111 (including calendar date), ending time 113 (including calendar date), and duration 115 of conversation 101.

In a related embodiment, both starting time 111 and ending time 113 are stored in conversation record 301, and duration 115 is not explicitly stored in conversation record 301, but is computed when needed, as the difference between ending time 113 and starting time 111. In another embodiment, only a single time (such as starting time 111) is stored, and duration 115 is preferably stored explicitly. Whether stored explicitly as a separate data item (e.g., duration 115) or computed as needed from starting time 111 and ending time 113, the effect is functionally the same, and therefore a conversation duration is herein considered to preferably exist as a definite value regardless of whether it is explicitly stored or computed as needed.

Conversation record 301 also contains a reference 305 to second party 105. In cases where a conversation involves a third party (as illustrated in FIG. 2) or an arbitrary number of additional parties, a reference to each of the additional parties is included in the conversation record. As described previously, the data of conversation record 301 can be based on a telephone log of telephone 171 or on an entry of calendar 173.

FIG. 3B illustrates a subject 351 which can be suggested as a topic for social conversation, according to various embodiments of the present invention. In these embodiments, subject 351 includes subject content 353, publication time 355, and a publisher identifier 357. In a related embodiment, subject content 353 includes text identifying the subject matter. In another embodiment, subject 351 includes a subject digest 359, which is a concise text description of subject content 353. In a related embodiment, subject digest 359 is a headline or text heading for subject content 353, and may be pre-existing as part of subject content 353. In another related embodiment, subject digest 359 is derived from subject content 353 and is not included in subject 351, but is obtained therefrom when needed.

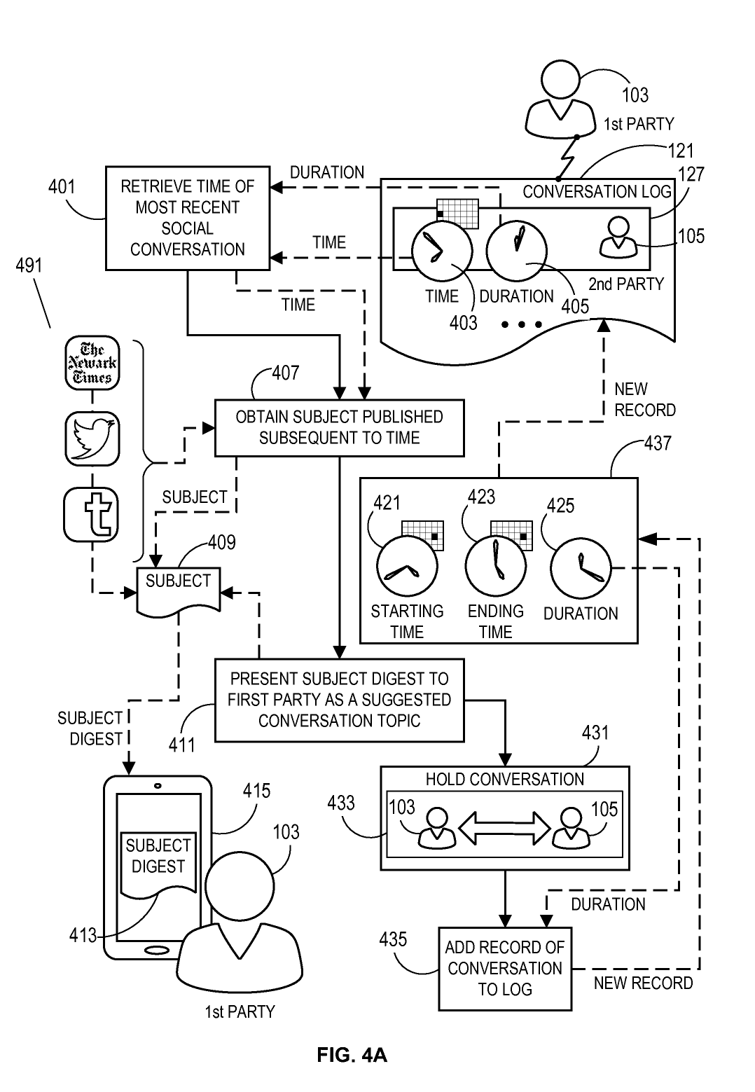

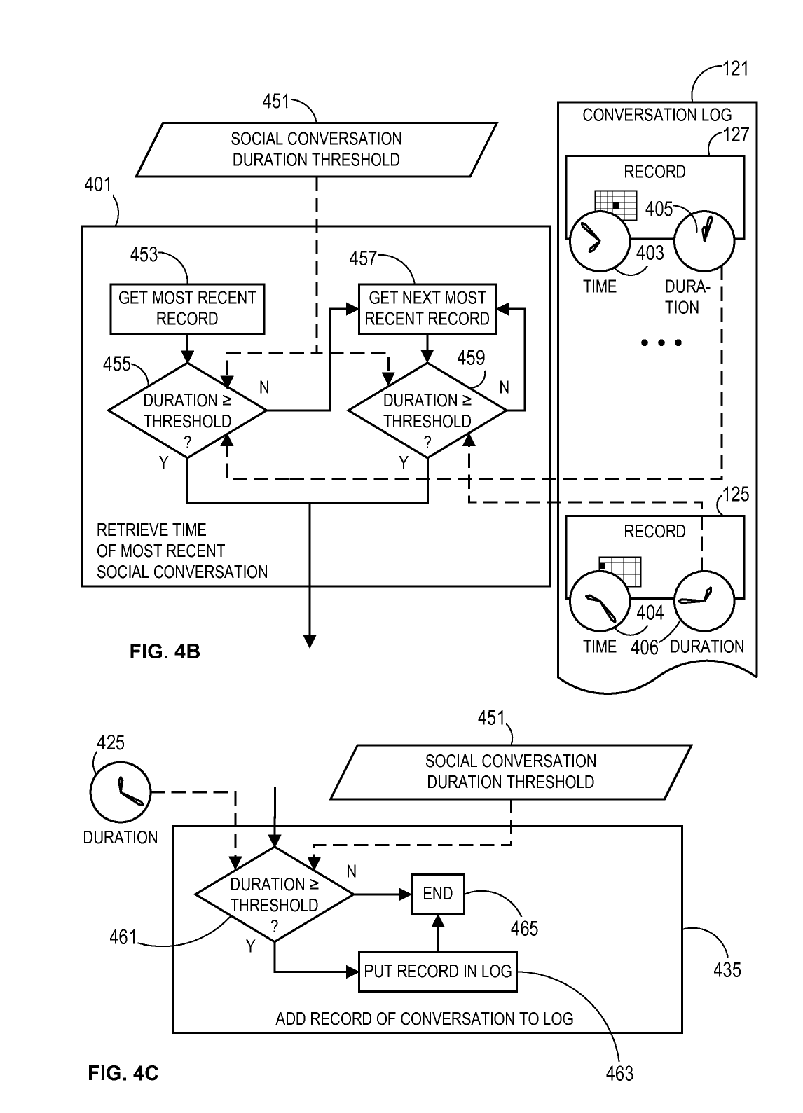

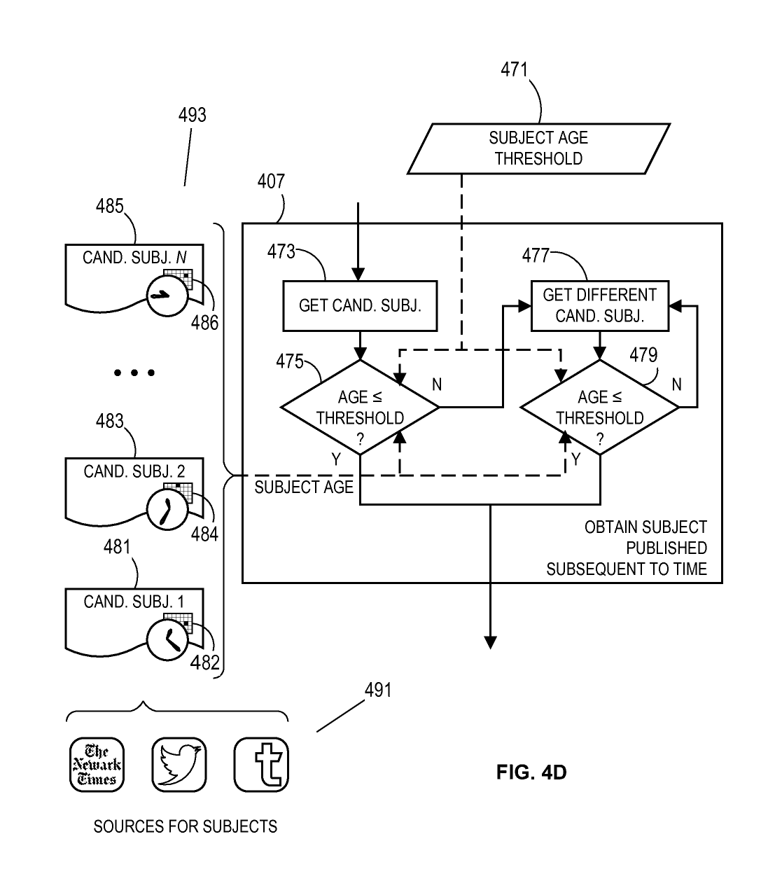

FIG. 4A is a flowchart of a method for suggesting a topic for a social conversation between first party 103 and second party 105 according to certain embodiments of the present invention. The method starts at a step 401, which retrieves the time of the most recent social conversation between first party 103 and second party 105 from a conversation log of first party 103, exemplified by conversation log 121. Conversation record 127 of conversation log 121 indicates the most recent conversation between first party 103 and second party 105 as having been held at a time 403, and having lasted a duration 405. In a related embodiment, time 403 is chosen as the starting time of the conversation of conversation record 127. In another related embodiment, time 403 is chosen as the ending time of the conversation. In still another embodiment, time 403 is a time between the starting time of the conversation and the ending time of the conversation. In a further embodiment, time 403 is an approximate time relative to the starting time and the ending time of the conversation.

In other embodiments of the present invention (detailed below), step 401 is augmented by further steps for selecting the most recent social conversation.

After step 401, a step 407 receives time 403 from step 401 and continues by obtaining a subject 409 having a publication time subsequent to time 403. In a related embodiment, obtained subject 409 is related to first party 103; in another related embodiment, obtained subject 409 is related to second party 105. Subject 409 is obtained from a set 491 of subject sources.

According to various embodiments of the invention, in a step 411, subject 409 is presented to first party 103 as a suggested topic for a conversation. In a related embodiment, a subject digest 413 is displayed on the screen of a personal device 415 of first party 103.

According to a further embodiment of the present invention, in a step 431 first party 103 and second party 105 hold a telephone conversation 433. In this embodiment, step 411 is performed prior to the holding of conversation 433 in step 431. In a related embodiment, step 411 is performed during conversation 433.

In another embodiment of the invention, a step 435 is performed at the conclusion of conversation 433 to add a conversation record 437 of conversation 433 to conversation log 121. Conversation record 437 includes a starting time 421, an ending time 423, and a duration 425.

According to a further embodiment of the present invention, a party may simultaneously utilize several devices with respect to a social conversation. In a non-limiting example, party 103 may utilize smartphone 415 for conducting the voice call of the conversation, and may also utilize another device, such as notebook computer 163 (FIG. 1), to present suggested topics of conversation before or during the conversation. In this embodiment, information related to the voice call is transferred as needed between smartphone 415 and notebook computer 163.

In a related embodiment of the invention, duration 425 is an input to step 435, as described below.

Discriminating Social Conversations from Non-Social Voice Communications

Various embodiments of the present invention discriminate social conversations from non-social voice communications. As an example, consider the following interactive voice communication between a first party (“Alice”) and a second party (“Bob”):
Alice: “Hi Bob, just getting back to let you know it's OK to borrow my car this afternoon.”
Bob: “Thanks. Like I said, I'll only need it for about an hour.”
Alice: “All right, I'll leave the keys with the receptionist at the front desk. She'll be expecting you.”
Bob: “Great. I'll be over to get them in about five minutes, and I'll drop them off with her when I'm done. Thanks again.”

The above is an example of a commonplace and useful voice communication, but it does not fit into the scheme of social conversation in the context of discussing a subject. In particular, the information exchanged by the participants in the above voice communication is ephemeral and of no lasting interest; the participants are not discussing a subject with a meaningful conversation topic. Therefore, according to certain embodiments of the invention, a voice communication of this sort does not qualify as a social conversation.

In a related embodiment, a voice communication is considered to be a social conversation if the duration reaches or exceeds a predetermined threshold of time. According to this embodiment, shorter voice communications tend not to be social conversations, whereas longer voice communications tend to be social conversations. Thus, in a non-limiting example, a voice communication is considered to be a social conversation if it has a duration of at least five minutes.

FIG. 4B is an expansion of step 401 for a variation of the method shown in FIG. 4A, according to an embodiment of the present invention. In a step 453 the most recent record in conversation log 121, record 127, is obtained. The conversation of record 127 has a duration 405, which is compared against a social conversation duration threshold 451 at a decision point 455. If duration 405 meets or exceeds threshold 451, then step 401 concludes with the result that the most recent social conversation is the social conversation of record 127, and the method of FIG. 4A continues at step 407. If, however, duration 405 is less than threshold 451, in a step 457 the next most recent conversation record in conversation log 121, record 125, is obtained, for a conversation held at a time 404 with a duration 406. If duration 406 meets or exceeds threshold 451, then step 401 concludes with the result that the most recent social conversation is the social conversation of record 125, and the method of FIG. 4A continues at step 407. If, however, duration 406 is also less than threshold 451, then step 457 is repeated as needed to obtain the record of the most recent social conversation. In a related embodiment of the invention, if no record of a social conversation is found, then the present conversation is considered to be the first social conversation, and the time input to step 407 in FIG. 1 is the current time.

FIG. 4C is an expansion of step 435 for another variation of the method shown in FIG. 4A, according to an embodiment of the present invention. This expansion also relates to discriminating social conversations from non-social voice communications, and handles the discrimination in a different manner from that illustrated in FIG. 4B as described above. In this embodiment, conversation log 121 contains only records of social conversations and excludes records of voice communications which are not social conversations. Therefore, according to this embodiment, all records retrieved from conversation log 121 are guaranteed to be records of social conversations and do not require filtering, such as illustrated in FIG. 4B. To accomplish this, step 435 includes a decision point 461, which compares duration 425 of the current conversation (conversation 433 in FIG. 4A) against threshold 451. If duration 425 meets or exceeds threshold 451, then in a step 463 the record of the current conversation (conversation 433 in FIG. 4A) is placed in the conversation log (conversation log 121 of FIG. 4A). If, however, 425 is less than threshold 451, then step 435 terminates at an end-point 465 without adding the record to the conversation log.

### Selecting Fresh Subjects

According to various embodiments of the present invention, topics for discussion should be current and up-to-date. It may happen, however, that the most recent social conversation involving the parties was held a long time ago, in which case a subject published subsequent to the time of that social conversation (such as a subject obtained by step 407 in FIG. 4A) may be dated and no longer recent. To avoid such a situation, a further embodiment of the present invention provides for selecting a subject that was published at a suitably-recent time.

FIG. 4D is an expansion of step 407 for a variation of the method shown in FIG. 4A, according to a further embodiment of the present invention. In this embodiment, candidate subjects (prospective subjects) are first selected and then examined to see if they are eligible as subjects according to their age of publication, with a goal of assuring that subjects presented as conversation topic suggestions are recent enough to be suitable as conversation topics. In a step 473, a candidate subject 481 having a publication time 482 (calendar date and optionally a clock time) is selected from a set of candidate subjects 493 obtained from sources 491, such that all candidate subjects 493 were published subsequent to time 403 (FIG. 4A). At a decision point 475 the age of candidate subject 481 is compared against a predetermined subject age threshold 471. In this embodiment, the age of a subject is the subject's publication time subtracted from the current time. This calculated age is input into decision point 475. If the age of candidate subject 481 is less than threshold 471, then candidate subject 481 is selected as subject 409 (FIG. 4A) and the method continues with step 411 (FIG. 4A). If, however, the age of candidate subject 481 is equal to or greater than threshold 471, the method continues with a step 477, in which a different candidate subject is selected, such as a candidate subject 483, with a publication time 484, or a candidate subject 485 with a publication time 486. If the age of the candidate subject is less than threshold 471, then the candidate subject is selected as subject 409 (FIG. 4A) and the method continues with step 411 (FIG. 4A). If, however, the age of the candidate subject is equal to or greater than threshold 471, the method returns to step 477, until a candidate subject is found whose age is less than threshold 471, and this suitable candidate subject is then presented as subject 409 (FIG. 4A).

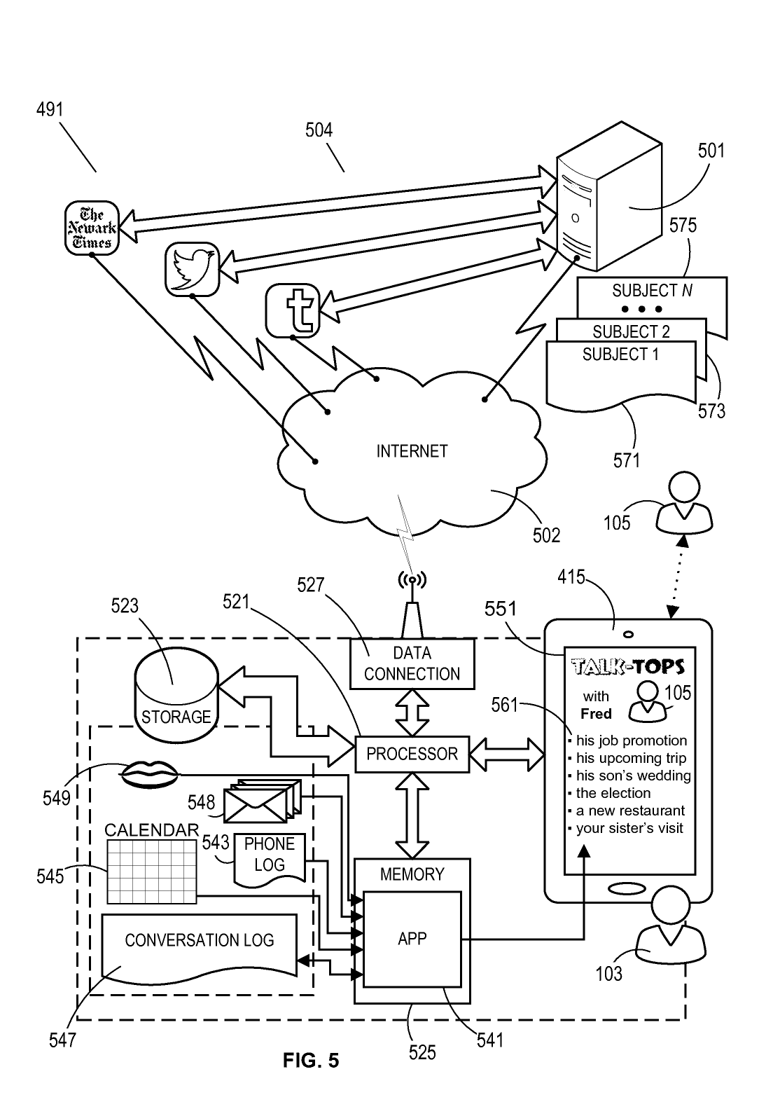

FIG. 5 conceptually illustrates a system and apparatus for suggesting social conversation topics to a user, according to an embodiment of the present invention. User device apparatus 415 of party 103 provides voice communication capability to party 103, and includes a processor 521 with a non-transitory data storage 523, non-transitory active memory 525, and a data connection 527 to Internet 502. A social conversation topic app 541 is contained in active memory 525 and runs on processor 521 to perform methods as described previously for other embodiments of the present invention. In particular for this embodiment, app 541 maintains a conversation log 547 for party 103 and has access all or some of the following resources which are maintained by user device 415: a telephone log 543 of party 103; a calendar 545 of party 103; e-mail messages 548 of party 103, and the content thereof; and voice communication content 549, gathered in whole or in part by user device 415. In a related embodiment, a server 501 is connected to Internet 502 and has access to prospective subject sources 491, which are also connected to Internet 502, so that server 501 can establish virtual connections 504 to prospective subject sources 491 as shown. In this related embodiment, server 501, by a request from app 541, compiles one or more subject digests relating to first party 103 and/or second party 105, resulting in exemplary subjects 571, 573, and 575. In a related embodiment, subjects 571, 573, and 575 are or contain subject digests. Server 501 sends subject digests to app 541 for a display 561 on a display screen 551 of user device 415 as suggestions for topics for first party 103 when holding a social conversation with second party 105.

In another related embodiment, user device 415 performs all the steps of the methods without requiring server 501. In still another embodiment, server 501 maintains conversation log 547.

An additional embodiment of the invention provides a first computer product including a set of executable instructions stored on non-transitory storage media, which instructions, when executed by a user device with a processor, cause the processor of the user device to present a suggested topic to a first party for a current or anticipated social conversation with a second party. In this embodiment, the executable instructions of the first computer product cause the processor to access a telephone log of the first party, to find the time of the most recent social conversation between the first party and the second party, and to request from a remote server a published subject of interest for the current or anticipated social conversation, such that the published subject of interest was published subsequent to the most recent social conversation between the first party and the second party.

A further embodiment of the invention provides a second computer product including a set of executable instructions stored on non-transitory storage media, which instructions, when executed by a server, cause the server to receive from a user device a date of a recent social conversation between a first party and a second party, and then to obtain, from a source of published subjects of interest, a subject of interest for a current or anticipated social conversation between the first party and the second party which was published subsequent to the date of the recent social conversation, and to send the subject of interest to the user device.

While the invention has been described with respect to a limited number of embodiments, it will be appreciated by persons skilled in the art that the present invention is not limited by what has been particularly shown and described herein. Rather the scope of the present invention includes both combinations and sub-combinations of the various features described herein, as well as variations and modifications which would occur to persons skilled in the art upon reading the specification and which are not in the prior art.

What is claimed is:

1. A method of operating a processor for suggesting to a first party a conversation topic for a social conversation with a second party, the method comprising:
retrieving, from a conversation log of the first party, a time of the most recent social conversation involving the first party and the second party;
obtaining a recently-published subject that was published subsequent to the time of the most recent social conversation; and
presenting, to the first party, at least a portion of the recently-published subject, as a suggested conversation topic.

2. The method of claim 1, wherein the social conversation involves also at least a third party.

3. The method of claim 1, wherein obtaining a recently-published subject is obtaining a recent posting by the first party in social media.

4. The method of claim 1, wherein obtaining a recently-published subject is obtaining a recent posting by the second party in social media.

5. The method of claim 1, wherein the recently-published subject is a news item.

6. The method of claim 1, wherein a voice communication is considered a social conversation for the retrieving only if the voice communication has a duration that exceeds a predefined minimum threshold of time.

7. The method of claim 1, further comprising:
recording a time of the social conversation in the conversation log of the first party.

8. The method of claim 1, further comprising:
if the social conversation has a duration that exceeds a predefined minimum threshold of time, then recording a time of the social conversation in the conversation log of the first party.

9. The method of claim 1, wherein obtaining a recently-published subject includes verifying that the recently-published subject was published within a predetermined time interval prior to a time of the social conversation.

10. The method of claim 1, wherein the social conversation is conducted face-to-face, and the processor is part of a portable computing device carried by the first party.

11. The method of claim 1, wherein the conversation log is at least partly based on a source selected from the group consisting of:
a telephone log that registers telephone conversations;
a calendar that registers scheduled face-to-face or electronic meetings;
content of an e-mail message; and
an analysis of a verbal communication.

12. The method of claim 1, wherein the social conversation is conducted in a voice call via a computing device, and wherein the obtaining and presenting are made by a processor of the computing device.

13. The method of claim 1, wherein the social conversation is conducted in a voice call made by the first party via a smartphone, and wherein the retrieving, obtaining, and presenting are made by a processor of a computing device that is separate from the smartphone, the method further comprising:
transferring information related to the voice call between the computing device and the smartphone.

14. An apparatus for suggesting to a first party a conversation topic for a social conversation with a second party, the apparatus comprising:
a processor, for executing instructions;
a display screen coupled to the processor, for displaying information; and
a non-transitory data storage coupled to the processor, and storing executable instructions, which instructions, when executed by the processor, cause the processor to perform:
retrieving, from a conversation log of the first party, a time of the most recent social conversation involving the first party and the second party;
obtaining a recently-published subject that was published subsequent to the time of the most recent social conversation; and
presenting to the first party, via the display screen, at least a portion of the recently-published subject as a suggested conversation topic.

15. The apparatus of claim 14, wherein the apparatus is a smartphone.

16. The apparatus of claim 14, wherein the social conversation is conducted in a voice call made by the first party via a smartphone, and wherein:
the apparatus is a computing device that is separate from the smartphone; and
the instructions further cause the processor to perform:
transferring information related to the voice call between the computing device and the smartphone.

17. A computer product for suggesting to a first party a conversation topic for a social conversation with a second party, the computer product comprising non-transitory media containing a set of executable instructions, which instructions, when executed by a processor of a user device cause the user device to:
access a telephone log of the first party;
determine a time of the most recent social conversation between the first party and the second party from the telephone log;
request from a remote server a published subject of interest for the social conversation, such that the published subject of interest was published subsequent to the recent social conversation between the first party and the second party; and
present the published subject of interest to the first party as a suggested topic of social conversation.
